(19) United States
(12) Patent Application Publication
(10) Pub. No.: US 2011/0094967 A1
(43) Pub. Date: Apr. 28, 2011

(54) COMPOSITE MATERIAL COMPOSED OF POLYMER MATERIALS AND A POROUS MINERAL MATRIX AND THE PRODUCTION AND USE THEREOF

(75) Inventor: Peter O. Glienke, Berlin (DE)

(73) Assignee: INOTEC GLIENKE & GLIENKE (GBR), Berlin (DE)

(21) Appl. No.: 12/985,295

(22) Filed: Jan. 5, 2011

Related U.S. Application Data
(63) Continuation-in-part of application No. PCT/DE2009/000943, filed on Jul. 6, 2009.

(30) Foreign Application Priority Data
Jul. 7, 2008 (DE) 10 2008 032 033.1

(51) Int. Cl. C08K 3/34; C08K 11/00; C08K 7/28; A01G 31/00; B01D 15/00

(52) U.S. Cl. 210/660; 524/445; 524/446; 524/447; 524/15; 523/219; 524/73; 47/59 S

(57) ABSTRACT

The present invention relates to a composite material, particularly a composite material designed as a molded body and/or suited for the production of molded bodies, composed of polymer materials and a porous mineral matrix, said composite material expanding under the action of liquids, particularly aqueous liquids and/or aqueous oil emulsions, and storing said liquids, characterized in that the matrix it comprises includes crushed and/or ground, open-pored, expanded/expanded perlite in the form of sharp-edged perlite particles and at least one natural and/or synthetic cross-linked and/or partially cross-linked polymer and/or polymer forming a hydrogel.

### TECHNICAL FIELD

The present disclosure generally relates to a composite material, and more particularly to a composite material designed as a molded body or suited for the production of molded bodies, composed of polymer materials and a porous mineral matrix, and the production and use thereof.

### BACKGROUND

It is known that cross-linked polyacrylic acids and/or copolymers on the basis of polyacrylic acids, referred to as polyacrylates in the relevant specialist literature, in particular in a salt form, are capable of absorbing a multiple of their own weight in water, aqueous liquids, and even oil/water dispersions and/or suspensions, and, whilst forming hydrogels, of binding the same. Polyacrylic acid is a colorless substance that dissolves easily in water. The glass transition temperature lies at above 100° C. Above 200° C. up to 250° C. the polymer loses water, whereby insolvable cross-linked anhydrides are created. From approx. 350° C. upwards decomposition into carbon dioxide and hydrocarbons takes place.

Different methods, but mostly solution polymerization in water, precipitation or emulsion polymerization, can be used for producing polyacrylic acids, whilst the hydrolysis of acrylic acid derivatives (ester, nitriles, amides) has gained in importance. A particularly large characteristics spectrum is possible through copolymerization with other co-monomers. Polyacrylic acid is available as a commercial product in its acid or salt form.

Cross-linked or partially cross-linked polyacrylic acids such as potassium or sodium salts of polyacrylic acid are preferably used as so-called super absorbent polymers with extreme liquid absorbing capacity (hereafter described as SAP or super absorbers), for example in baby diapers or sanitary towels. Further uses are found in the packaging of moisture sensitive or liquid emitting foods or as a gel former during medicine production. The SAP is present in a cross-linked and/or a partially cross-linked form for all the above mentioned applications. Cross-linking is necessary in order to guarantee the insolvability of the SAP in water. The gaps and hollows within the network are filled with water. In this way a hydrogel is created.

Super absorbers can absorb a multiple of their own weight in water, whereby the same swell up to form a hydrogel. Polymer chains, in particular polyacrylic acid, are linked with each other through scattered covalent bindings. This light cross-linking is necessary to guarantee the insolvability of the SAP in water. Hydrogel is a hydrophilic polymer network swelled in water or in aqueous liquids. The characteristics of these gels depend on the interaction between network and the surrounding liquid. In ionic gels the osmotic contribution of the ionized groups must taken into consideration, as this has a large effect on the swelling characteristics of the gels.

For example, the acrylic acid groups in a polyacrylic acid gel are arranged immediately adjacent to each other. The identical charges of the disassociated carboxylate groups will repel each other, whilst the polymer chains will expand and the gel swell in an extreme way. Such networks can absorb up to 1000 grams water per 1 gram polymer. Thanks to this product characteristic cross-linked polyacrylic acids are known as super absorbers.

It therefore suggested itself to use the water binding capability of the SAP by using the same as water stores in dry ground, in particular when it is desired to regulate and safeguard water supplies in hot climate zones, in that the water required for plant growth should not evaporate rapidly and can be bound and delivered to the plants over a longer period of time.

Numerous application examples and studies have been published in the relevant professional and patent literature, in particular during the last ten years. In principle it is always recommended that SAP is introduced into the ground structure by means of suitable mechanical devices.

It is, however, a disadvantage that SAP tends to agglutinate and does not comprise a plant earth structure themselves, so that although, for example, water can be bound in the desert sand ground applications in desert regions, a structure that would enable successful planting cannot be created or realized.

SAP can be used under certain conditions and with adequate effect only, when the same has already been introduced into ground substrates, the structure of which is suitable for planting with crop plants. In addition SAP emits the bound water sometimes only with great difficulty, and is therefore not available for plant growth as intended. Furthermore, relatively large admixtures of SAP are required in order to achieve an effect, and their use can be very cost intensive. Due to these disadvantages the use of SAP on an acrylic acid polymer basis and other polymers within this area has not been able to establish itself to date.

Products that supposedly rectify the above problem have recently become known. These products for example incorporate fine lava flour introduced and bound into the polymerizate.

Such SAPs, their production and application areas are for example described in WO2003000621A1. Although the use of such SAPs filled with lava rock flour or other, similar porous rock and/or rock flour, offers some improvement in its use, these are mostly spongy, rough grained granulates, the surface of which is sticky and which may cake under pressure. These granulates remind one of porous rubber granulate in their consistency. The production of fine granulates with an earth like structure is not possible with this method. These products are also very expensive due to the complex production process. Their use in dry and desert regions is therefore possible only at great cost, and therefore of little economic interest.

Further substantial disadvantages of the use of such SAPs are due to the fact that the so-called ground improvement agent will become rock hard when water evaporates from these SAPs, and the appearance and hardness of the shape formed upon water extraction resembles pebbles and therefore in way contributes to improving the ground structure, in particular when used in a surface area. There will be a risk that tender plant shoots are crushed.

In EP0647093B1 it is suggested that perlite or vermiculite be added to the matrix consisting of porous foamed hydrophilic and water retaining hydrogel material comprising open cells. Although the porous spongy structures resulting from this are suitable as a substrate with water storage effect for the propagation of plants, they are not suitable as a ground improvement product with a long-term water storage effect. In addition the expanded perlite that is not present in the form of expanded broken and/or ground perlite spheres but in an irregular spherical form serves as a water storing filler, and not as a matrix for the water retaining hydrogel plastic material. This also applies for the suggested expanded filler vermiculite.

### SUMMARY

The present disclosure relates to a composite material, particularly a composite material designed as a molded body and/or suited for the production of molded bodies, composed of polymer materials and a porous mineral matrix, said composite material expanding under the action of liquids, particularly aqueous liquids and/or aqueous oil emulsions, and storing said liquids. The composite material preferably serves as a ground improvement product with a long-term water storage effect. The term composite material hereafter denotes not only finished products, but also intermediate products such as for example material mixtures envisaged for the production of finished products and/or preferably for the treatment of and/or introduction into natural ground and earth substrates and/or ground and earth structures, in particular for improving ground structures and/or increasing the water storage capacity of dry ground.

Disclosed are several embodiments of the composite material suitable for various applications, methods for producing the composite material, and preferred applications of the same.

A desirable composite material for storing liquids can be produced cheaply, and avoids the disadvantages mentioned in the background. Ideally, such a composite material should expand under the influence of water and/or liquid using the water storing characteristics of the SAP, and form a finished plantable ground substrate whilst binding the water, or through admixing with non-plantable ground structures convert and loosen the same in such a way that they are converted into a plantable ground substrate following introduction of this composite material and subsequent sprinkling, the same having plant growth supporting water storage capabilities and being capable of binding a multiple of its own weight in water, and also of delivering the same to the plants or the seedlings.

This desirable composite material, which is capable of storing and releasing a liquid, comprises at least 1 weight percent of sharp-edged perlite particles. More preferably, the composite material comprises between 5 and 95 weight percent of perlite particles with a particle size of less than 100 micrometer. The perlite particles are made of ground or broken perlite in its expanded state with open pores. The composite material further comprises at least one natural and/or synthetic cross-linked and/or partially cross-linked polymer and/or copolymer forming a hydrogel as a matrix. The polymer and/or copolymer has the characteristics of a super absorbent polymer (SAP) and comprises at least 0.3 weight percent of the composite material. Through the absorption of water the SAP can form a hydrogel, with the water contributing between 10 and 60 percent of the mass of the hydrogel, or the water contributing between 10 and 60 percent of the volume of the hydrogel, or both. The composite material further comprises an inorganic additive, which may be made of eruptive rock, clay minerals, sedimentary rock, or a combination thereof

Perlite primarily denotes an altered (chemically and physically converted) volcanic glass (obsidian), and therefore represents rock. It consists of an aluminum silicate with a silicon dioxide content of more than 70%. Particularly characteristic for raw perlite is the fact that water is enclosed in the same, namely between 2-5% in the total mass. If the broken down and pre-dried rock, namely the raw perlite, is subjected to temperatures of around 1000° C. the material will expand and a very light and porous, open-pored granulate consisting of cellular spherical particles will be created, which is described as “industrially” expanded perlite. However, use of “naturally” expanded perlite can also be advantageous. Depending on the content and the enclosed water of crystallization within the perlite rock, i.e. the raw perlite, the same will expand to around 15-20 times of its original volume. Depending on the grain size bulk densities can lie between forty and a hundred kilograms per cubic meter.

The main areas of application for expanded perlite are heat insulation, cavity wall insulation, and use as filler and additive within the construction industry. In addition, expanded perlite is used in the garden and landscape industry, and as an additive for plant substrates.

Expanded perlite with a grain size of between 2-6 mm has a pore volume of more than 90 volume percent, and a water storage capacity of more than 50 volume percent. As a light, highly porous, and chemically inert substrate expanded perlite serves for the cultivation of vegetables and cut flowers as a ground or peat substrate replacement. Plants are cultivated in the expanded perlite here and can be supplied with water and nutrients in a controlled way. Ground or broken down perlite is also used as a filtration aid, and is classified according to particle size, which can be matched to suit the desired filtration effect.

Throughout the industrial process of expanding perlite rock, starting with the breaking down and classification of the raw perlite into the respective grain sizes, unexpanded perlite dust is created and captured in filters. Also, rather large quantities of unclassified perlite particles are generated during the various expanding, grinding and breaking processes during the preparation of expanded perlite, the particle size of which covers a range from zero to a maximum of one hundred micrometers, but on average equals around fifty micrometers, and which comprises a fluffy, irregular, jagged structure. The bulk density of these perlite particles is between 50 and 100 grams per liter, that of unexpanded perlite dust and/or perlite powder between 650 and 850 grams per liter, depending on the particle size and distribution. There are practically no uses or application areas for these waste products, namely perlite dust and expanded fine perlite particulate matter.

It has now surprisingly been found, that the open-pored, expanded particles are ideally suited for the construction of a composite material with a super absorbent polymer, and that the waste product expanded perlite dust can also be used as a ballast additive. The expanded perlite particles and the unexpanded perlite dust are inexpensive, and therefore ideally suited for the cost effective production of composite material and molded bodies.

It should further be noted, that these open-pored, expanded perlite particles are also capable of absorbing and storing more than 50 volume percent water. Surprisingly, it can also be said that even the mixing of the expanded perlite particles with the crystalline SAP, such as for example with hygroscopic potassium polyacrylate, results in free flowing composite materials that will not agglutinate. Humidity in the air and/or an addition of small quantities of water will create a binding and fixation of the polyacrylate particles to the perlite particles.

The following detailed description illustrates aims, characteristics, advantages and application possibilities of the claimed subject matter. It is merely exemplary in nature and is not intended to limit the claimed subject matter, its application and use.

### BRIEF DESCRIPTION OF THE DRAWINGS

Not applicable.

### DETAILED DESCRIPTION

Unless specified differently, the following examples and teachings in refer to a hydrogel forming SAP based on potassium polyacrylate (specifically Luquasorb 1280 RS distributed by the company BASF). This is merely exemplary, and to improve readability and comprehension of the teachings.

Luquasorb 1280 RS is defined in line with drawing V130807 (BASF):

| Type of polymer product | Potassium | |
|---|---|---|
| | polyacrylate | |
| Appearance | Granulate | |
| Absorption capacity (g/g) | 26 | |
| NaCl 0.9% | | |
| pH (at 5 g/l NaCl 0.9%) | 5.5-6.5 | |
| Specific gravity (g/ml) | approx. 0.6 | |
| Vortex test (sec) | <20 | |
| Residual monomers (ppm) | <400 | |
| Particle size distribution (%) | >850 μm | <0.1 |
| | 500-850 μm | 1 |
| | 300-500 μm | 41 |
| | 150-300 μm | 43 |
| | 45-150 μm | 15 |
| | <45 μm | 0.2 |

### EXAMPLE 1

In a first embodiment 80 kg of expanded, open-pored perlite particles with an average particle size of less than 50 μm, are filled into a pug mill mixer. 20 kg of SAP is added at a temperature of 20° C. and admixed homogeneously. Following a mixing time of approximately 10 minutes a free flowing, homogeneous composite material results, which can be compressed with the aid of suitable devices such as for example flat die presses, annular die presses, tablet presses, or other compression technologies, and formed into molded bodies, preferably in the shape of pellets and tablets.

Example 1 shows a typical composite material as claimed, the same being ideally suited as a ground improvement agent with water absorption characteristics as well as an earth substrate additive. This composite material is capable of absorbing water whilst expanding its volume up to 40 times its own weight, and of storing and once more releasing the same. Once the bound water has been released, namely once the hydrogel condition has been removed by evaporating the absorbed water and/or releasing the water, for example to plants, the composite material is capable of absorbing, storing and releasing water once again.

Other hydrogel forming polymers and/or copolymers can be used for producing the composite material, in place of the potassium polyacrylate polymer used in example 1. In this way it is possible to produce tailor-made composite materials for specific applications. The selection of the hydrogel forming polymers and/or copolymers will depend on the desired product characteristics and application areas.

Also, the content of hydrogel forming polymers and/or copolymers included in the claimed composite material and the content of open-pored, expanded perlite particles can be varied.

The composite materials produced according to example 1 display a strong binding of the stored SAP polyacrylates. It has, however, been found that the binding of these SAPs to and in the expanded perlite particles is substantially improved by adding SAP polyacrylates and the subsequent complete and/or partial conversion of the SAP polyacrylates.

This binding is not removed through subsequent drying of the composite materials composed and produced in this way, but is instead improved. These further developments of the invention with reference will hereafter be described by way of examples 2, 3 and 4, including their production and use.

According to a second example, 80 kg expanded, open-pored perlite particles with an average particle size of less than 50 μm is filled into a liquid mixer with rotation mixing blade: 67 kg of demineralized water is introduced into this material base, mixed until the water is completely absorbed by the perlite particles. 20 kg SAP is added via a powder dosing means, and the mixing process continued until a homogenous, free flowing composite material results, with a composition of around:

| | |
|---|---|
| Perlite particles | 48.00 weight percent |
| Water | 40.00 weight percent |
| SAP | 12.00 weight percent |

During the mixing process the temperature increases to 35° C. Despite the water content of 40.00 weight percent in the composite material the same feels very dry, and can be packed in this form without subsequent drying as a finished product. A water content of at least 10 percent is desirable.

The composite material of example 2 can, for example, be used as a ground firming agent, for admixing with plant earth, or as a plant substrate, the water storage capability of which must be increased. The added quantity for these applications will depend on the water binding capacity to be realized. It is also possible to introduce this composite material directly into dry earth. The composite material has an average water binding capacity of more than 20 times its own weight and will expand and increase its volume up to 25 times it original volume.

In a third example, the composite material of example 2 is dried in a vacuum drier and/or continuous-flow drier to a rest water content of less than 50.00 weight percent and then formed into molded bodies by means of tablet and pellet presses whilst applying pressure.

These molded composite material bodies are particularly suitable for use as water stores, when the same are to be used selectively, for example for introducing into planting holes for trees or bushes, or for use as water stores in planted troughs, or example for house plants.

In a fourth example the water content is increased to more than 50.00 weight percent during the mixing process of example 2. This produces the claimed composite material in a fluffy, porous, soft, and gel like agglomerate form. The particle size will be substantially influenced by the water content in the composite material.

For this process the following is filled into a rotation mixer: 50 kg expanded, open-pored perlite particles with an average particle size of less than 50 μm, and 50 kg demineralized water, whereafter 50 kg SAP is introduced. 140 kg of demineralized water is added to this homogenous, free flowing, powdery composite material, and the mixing process continues until an agglomerate formation results.

The agglomerate particles produced in this way have a particle size of between 3000-6000 μm, and have a gel like, soft consistency as well as homogeneous but porous material structure. The composition of these agglomerate particles in rounded to weight percentages:

| | |
|---|---|
| SAP | 17.25 weight percent |
| Perlite particles | 17.25 weight percent |
| Water | 65.50 weight percent |

The agglomerate particles can, for example, be used for hillside cultivation and/or hillside compaction either directly or in admixture with other substrates. By drying the agglomeration particles, for example in rotating continuous flow driers, at a temperature of more than 100° C. homogeneous irregularly shaped porous, pourable and pressure stable super absorber granulates will result, which are capable of absorbing and then releasing up to 40 times their own weight in water and/or in aqueous liquid. A volume increase is connected with the absorption of water and/or aqueous liquid.

This composite material, formed in the way of an agglomerate granulate, can for example be used on its own or in admixture with other materials as water binding drainage for roof planting. The water containing agglomerate particles can for example also be lightly formed into defined granulate strands by means of augers with upstream perforated discs, which can be cut to the desired length by means of rotating knife blades and then dried.

It has been found to be of advantage to incorporate organic and/or inorganic binding agents, preferably on the basis of sodium silicate and/or potash silicate, but also to add lignin compounds and/or lignin derivatives for compacting the granulate strands by means of suitable dosing devices during processing with augers. The lignin compounds or lignin derivatives are lignin sulfonate complexes which are formed as a conversion product of calcium lignin sulfonate with calcium oxide.

Through the addition of binding agents the firmness of the composite materials and their usage characteristics can further be substantially influenced.

To produce a ground improvement agent with structure lending and water storing characteristics, multiple factors and requirements have to be taken into consideration. This is realized by means of the basic composite of SAP and expanded, open-pored perlite particles. Also taken into consideration in principle for a respective product design for the area of ground improvement and long-term water storage must be the fact that such products must absorb and store large quantities of water during the swelling process, but must be able to emit this water to the plants, or the same must be absorbable by the plants.

An improvement of the ground capillarity is desired, whilst the ground quality should be influenced positively by admixing minerals at the same time. It is desirable that an appropriate product will not only store water when mixed with dry earth and subsequently sprinkled, but also expand, so that a loose, plantable ground structure results, into which seeds can be introduced. This set of problems has already been described in detail in WO2003000621A1.

It is of advantage that composite material, i.e. molded bodies made or produced from the same, can also be processed on site with the simplest of means and introduced into the areas to be worked with immediately, or combined through suitable mixing means, for example whilst adding water, with other earth and/or plant substrates to form a homogeneous composite material, which will then be introduced into the dry ground structure that is, for example, to be planted, in this form. This is illustrated by way of the following example 5:

In this example the following is filled into a mobile, rotating pug mill mixer with a discharge device: 10 kg of a ground substrate on the basis of CFP with an organic fiber content and a moisture content, namely a water content, of 40.00 weight percent. 200 kg of the claimed composite material is mixed with this substrate mixture, of the following composition and in powder form, with a particle size of less than 1000 μm:

| | |
|---|---|
| Perlite particles | 80.00 weight percent |
| SAP | 20.00 weight percent |

Following the homogeneous mixing of this claimed composite material an additional 1000 kg water is admixed. The ground and plant substrate prepared with the super absorber in this way is then applied onto the desert like ground area, namely onto sandy soil with a layer thickness of approximately 5-8 cm, and introduced into the sandy soil to a depth of approximately 10 cm with the aid of a harrow. The coverage per square meter of area is approximately 1400 kg for a total treated area of approximately 8000 m².

Following the additional sprinkling with water it was found that the ground area treated in this way is capable of absorbing a total of approximately 15,000 kg of water, and to bind and store the same depending on the wind conditions and the outside temperature, which in this example was an average of approximately 38° C. for a period of 14 hours per day and approximately 30° C. during the night, so that a residual moisture of approximately 30% of the original moisture could be measured even after 4 days.

It should be noted that the composite material does not result in ground agglomerations, as is the case with an introduction of conventional super absorbers. The application technical characteristics of the composite material of the invention are, as has already been explained, substantially influenced by the ratio of the content of expanded perlite particles and SAP in the composite material, and can be adjusted with the aid of further additives.

A further development is realized in that natural rock flour and/or rock granulate, preferably microporous rock flour and/or rock granulate, or rock flour and/or rock granulate that swells with the absorption of water, is added to the claimed composite material, or the molded body formed or produced from the same, which serve for the improvement of the ground structure on the one hand, and which are capable of supplying the plants with the relevant mineral nutrients on the other hand. These can for example be ground, unexpanded raw perlite, rock flour made from lava rock, or sedimentary rock such as trass, dolomite, bentonite, magnesite and feldspar. The rock flour has an average grain size of less than 200 μm. The composite material may further comprise coir fiber pith, preferably between 1 and 95 weight percent.

The addition of unexpanded perlite powder preferably takes place in the form of a very inexpensive ballast filler to achieve a higher specific gravity for the composite materials of the invention.

Of particular advantage is the addition of finest ground lava rock, as the plants are supplied with natural minerals essential for growth in this way, which has to date not been possible with the known methods and products that are added during the polymerisation of SAP in addition to the super absorber polymers lava rock and/or lava rock flour.

These composite materials of the invention are also ideally suited for absorbing and binding and/or treating contaminated and/or odor intensive liquids and suspensions, such as for example slurry, waste water and waste water sludge.

Thanks to the material structure and the characteristics of the expanded perlite particles in the combination with SAP it is possible in further embodiments that oil and/or contaminant degrading microorganisms and/or microorganisms supporting plant growth and/or microorganisms that fight and destroy animal parasites and/or their metabolic products can be introduced into the pores of the expanded perlite particles and/or bound to the same.

This also applies for the embedding of inorganic and/or organic fertilizers and/or pesticides and/or other functional effective ingredients and additives. These agents should preferably be activatable through the addition of water and/or soluble in water.

The introduction of herbicides, fungicides, insecticides, pesticides and bactericides into the claimed composite material or the molded body formed or produced from the same are further preferred embodiments.

Yet another preferred embodiment is the introduction of cellulose fibers, microcellulose, recycling paper fiber, wood chips, sawdust, wood shavings, hey, straw, coconut fiber and coconut shell flour, i.e. in general the introduction of organic additives and/or fillers of a preferably plant origin, into the composite material. In this way it is for example possible to produce flat structures and mats that resemble carton, that can for example serve as water storing mats and/or seed substrates or, also in connection with other flat substrate materials, for the cultivation of plants in wetlands and/or flooded areas.

These embodiments of the composite material and/or the molded bodies can also be used as oil binding agents and/or binding agents for water/oil emulsions, in particular in the form of pellets.

It is known that expanded perlite granulates, also expanded perlite particles, are capable of absorbing odors.

A further preferred embodiment includes the introduction of natural or synthetic aromas and/or aroma preparations, preferably on the basis of essential oils, into the claimed composite material and/or molded bodies. Such products are used as liquid storing and odor neutralizing materials to combat bad odors and discharged liquids with a bad odor, such as for example in organic waste collection bins. These products can also be used for odor absorption during the surface coverage of landfill sites or during the processing of waste water sludge.

It has further been found that the effect of the claimed composite material, namely to absorb odor, can be realized in that active carbon, preferably highly porous active carbon derived from coconut shells, is added, preferably in grain sizes of less than 1000 μm.

In a further preferred embodiment of the composite material the same contains between 1-95 weight percent CFP, as the SAP can be embedded into and/or onto the CFP particles and/or bound to the same. It is of particular advantage when additional fillers and/or active ingredients must be bound to the CFP and/or introduced into the same. This is realized by adding CFP during the production of the composite materials of the invention and/or by adding these composite materials and/or molded bodies to CFP.

A further preferred embodiment is realized in that an open-pored, expanded perlite in an unbroken form, preferably in a sphere like pearl form, is added to the composite material, and the particle size is preferably of a size distribution of between 200-1000 μm. This addition enables additional ventilation and loosening of the ground structure and improves the water storage capacity during its introduction, for example into heavy and sandy soil.

For special applications of the composite material, in particular when the ground structure is to be loosened and ventilated, it can be of advantage that expanded and unbroken perlite in pearl form is added, and that this is broken during the production of the composite material by applying pressure to open-pored perlite particles, the particle size of which is preferably less than 500 μm.

It has been found that a further preferred embodiment can be realized in that the composite material is formed as an aqueous suspension that can be applied by means of suitable application devices and/or spray and ejection aggregates. In this way it is especially possible to bind dust on paths and open spaces easily and without problem, and to optimally compact sandy slopes and verges when these suspensions comprise, for example, additional short plant fiber such as for example CFP or cellulose fiber.

The design, production and use of the composite material is not limited to the above mentioned preferred embodiments. Instead a multitude of design variations, production and application possibilities are feasible, which can utilize the solution illustrated even when the principle of the embodiment is substantially different. While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

What is claimed is:

1. A composite material, the composite material being capable of absorbing and releasing a liquid, comprising:
at least 0.3 weight percent of a super absorbent polymer (SAP);
an inorganic additive selected from the group consisting of eruptive rock, clay minerals, and sedimentary rock; and
at least 1 weight percent of perlite particles which are sharp-edged and porous.

2. The composite material as in claim 1 formed into a molded body.

3. The composite material as in claim 1,
further comprising water, the SAP and the water forming a hydrogel with the water contributing between 10 and 60 percent of the mass of the hydrogel, or the water contributing between 10 and 60 percent of the volume of the hydrogel, or both.

4. The composite material as in claim 1,
wherein the SAP forms a hydrogel when absorbing water,
and wherein the SAP at least partially reverses its hydrogel form when releasing water to below 15 weight percent of the composite material.

5. The composite material as in claim 1,
comprising 0.5-95 weight percent of perlite particles.

6. The composite material as in claim 1,
wherein the perlite particles have an average particle size of less than 100 μm.

7. The composite material as in claim 1,
wherein the perlite particles are finely ground and unexpanded.

8. The composite material as in claim 1,
further comprising at least one natural ground mineral rock.

9. The composite material as in claim 8,
wherein the at least one natural ground mineral rock has an average grain size of less than 200 μm and is selected from the group consisting of trass, dolomite, magnesite, bentonite, and feldspar.

10. The composite material as in claim 1,
further comprising between 1 and 95 weight percent of coir fiber pith.

11. The composite material as in claim 1,
wherein the perlite particles are open-pored expanded perlite in an unbroken form having a particle size between 100 and 1000 μm.

12. The composite material as in claim 1,
further comprising more than 10 weight percent of water.

13. The composite material as in claim 1,
further comprising lignin compounds or lignin derivatives.

14. The composite material as in claim 13,
wherein the further lignin compounds or lignin derivatives are lignin sulfonate complexes which are formed as a conversion product of calcium lignin sulfonate with calcium oxide.

15. The composite material as in claim 1,
further comprising highly porous active carbon.

16. The composite material as in claim 1 formed as a stable aqueous suspension.

17. A method for producing the composite material as in claim 1, comprising the steps of
mixing the SAP and the inorganic additive and
activating at least one hydrogel forming polymer or copolymer for connecting individual components of the composite material by adding water.

18. A method for producing the composite material as in claim 1, comprising the step of
breaking expanded, unbroken, perlite having a sphere like pearl form, into open-pored, sharp-edged perlite particles with a particle size of less than 500 μm.

19. A method for storing water and nutrients for growing plants in a ground, comprising the step of introducing the composite material as in claim 1 into the ground or mixing the composite material as in claim 1 with ground.

20. A method for absorbing, binding or treating a contaminated or odor intensive liquid comprising the step of providing the composite material as in claim 1 to absorb the contaminated or odor intensive liquid.
